(19) United States
(12) Patent Application Publication
(10) Pub. No.: US 2025/0279216 A1
(43) Pub. Date: Sep. 4, 2025

(54) FUSION SYSTEM HAVING TARGET TRACKING

(71) Applicant: XCIMER ENERGY, INC., Redwood City, CA (US)

(72) Inventor: Dennis Douglas, Makawao, HI (US)

(21) Appl. No.: 19/064,581

(22) Filed: Feb. 26, 2025

Related U.S. Application Data
(60) Provisional application No. 63/559,823, filed on Feb. 29, 2024.

(51) Int. Cl. G21B 1/19; G21B 1/23

(52) U.S. Cl. CPC G21B 1/19; G21B 1/23

(57) ABSTRACT

A fusion system and method generates an energy beam based on a trajectory of a target. The fusion system includes a reaction chamber, an energy pulse source, and a tracking system. The tracking system generates tracking data based on the trajectory of the target outside of the reaction chamber, and the energy pulse source is activated in response to determining that the trajectory is directed to a strike zone inside of the reaction chamber. The energy pulse source generates the energy beam to strike the target.

This application claims the benefit of priority from U.S. Provisional Application No. 63/559,823, titled “Fusion System Having Target Tracking” and filed Feb. 29, 2024, which is incorporated herein by reference in its entirety.

### FIELD

The present disclosure relates to fusion systems. More particularly, the present disclosure relates to fusion systems that direct an energy beam toward a target to generate energy.

### BACKGROUND

Fusion systems can be used for research purposes in high-energy physics, and are being investigated for use in energy production. Some fusion systems direct a higher-power source of energy, such as a laser beam, to a target containing fusion fuel. The target is typically positioned or launched into a containment chamber at a low pressure relative to ambient. The laser beam strikes the target to compress, heat, and ignite the target. When the target is sufficiently imploded in this way a fusion process begins. The fusion process can generate energy that may be harnessed, e.g., converted into electricity.

### BRIEF DESCRIPTION OF THE DRAWINGS

FIG. 1 depicts a schematic view of a fusion system, in accordance with an embodiment.

FIG. 2 depicts a side view of a beam steering system, in accordance with an embodiment.

FIG. 3 depicts a cross-sectional view of a target injection into a chamber, in accordance with an embodiment.

FIG. 4 depicts a cross-sectional view of a shutter apparatus in an open state, in accordance with an embodiment.

FIG. 5 depicts a cross-sectional view of a shutter apparatus in a closed state, in accordance with an embodiment.

FIG. 6 depicts a cross-sectional view of a target injection into a chamber, in accordance with an embodiment.

FIG. 7 is a flowchart of a method of generating an energy beam based on target tracking, in accordance with an embodiment.

FIG. 8 is a flowchart of a method of steering an energy beam based on target tracking, in accordance with an embodiment.

FIG. 9 is a block diagram of a computing device that may perform one or more method operations, in accordance with an embodiment.

FIG. 10 depicts an energy beam, including a cross-sectional view of the energy beam, in accordance with an embodiment.

### DETAILED DESCRIPTION

The following description sets forth numerous specific details such as examples of specific systems, components, methods, and so forth, in order to provide a good understanding of embodiments of the present invention. It will be apparent to one skilled in the art, however, that at least some embodiments of the present invention may be practiced without these specific details. In other instances, well-known components or methods are not described in detail in order to avoid unnecessarily obscuring the description of the exemplary embodiments. Thus, the specific details set forth are merely exemplary. Particular implementations may vary from these exemplary details and still be contemplated to be within the spirit and scope of the present invention.

To be commercially viable, laser-driven fusion systems are expected to operate at a sufficient repetition rate to generate energy goals. Accordingly, an energy beam, e.g., a laser beam, can precisely and repeatably, in a deterministic manner, engage targets in a reaction chamber to efficiently generate energy. Achieving such precision focused laser-target engagement has several fundamental technical challenges, as described below.

A first technical challenge is tracking and precisely engaging the target with focused laser pulses at a predetermined location within a reaction chamber. For example, the target can include a moving hydrogen (deuterium-tritium) (DT) target pellet that focused laser pulses are to engage at a center of the reaction chamber. The DT pellet may be shot toward the center from a mechanism located external to the reaction chamber. To achieve fusion, a series of focused laser pulses may be required to hit the center of the moving DT pellet with an accuracy of 25 microns. Achieving such accuracy is challenging and requires tracking of the target.

A second technical challenge is compensating for wavefront error (WFE) in the laser pulses to ensure diffraction-limited focus profiles engage the DT pellet at the center of the reaction chamber.

A third technical challenge is ensuring that a final amplified beam does not encounter anything physical except the target at the center of the reaction chamber. To effectively engage the target, laser beams may be amplified to the final amplified beam beyond a fluence threshold. WFE compensation mechanisms, e.g., optical elements or coatings, cannot operate effectively about the fluence threshold, e.g., the final amplified beam can damage the mechanisms.

A fourth technical challenge is maintaining vacuum of the reaction chamber when passing the laser pulses toward the target. Energies of the focused engagement laser pulses, which are required to initiate fusion, can break down a gas-filled laser transport medium. Accordingly, the final laser propagation distance towards focus, after final amplification, must occur in vacuum. A direct line of sight into the vacuum may also be needed to facilitate precision beam steering and WFE compensation prior to arrival at target in the chamber center. Achieving line of sight passage of laser pulses into a vacuum without intermediate optical elements is a challenge.

A fifth technical challenge is time synchronization of the firing of front-end laser sources with beam pointing and WFE compensation. Such timing can be critical to the laser pulses arriving at the target when planned to initiate fusion. Achieving synchronization while the target is in motion to the chamber center is challenging.

A sixth technical challenge is providing fail-safes to ensure that the amplified high energy laser pulses do not engage the target if precision targeting cannot be achieved. More particularly, avoiding laser pulse generation when fusion cannot be effectively initiated can provide a more efficient process. Achieving real-time fail-safes to avoid misfires is challenging.

A commercially viable fusion system is described below, which can overcome the above-listed technical challenges. The fusion system can provide a precise launch of each target in addition to active closed-loop tracking and beam steering capability to compensate for any variability in trajectory between successive shots. The system can incorporate a shutter apparatus to provide a sufficient line of sight time into the reaction chamber to the moving target as the target approaches the chamber center. The system can provide sufficient temporal bandwidth for fail-safe operation to avoid unnecessary laser pulse generation and to steer the laser beam in a time-synchronized manner to engage the target at the chamber center. The system can provide WFE compensation (in addition to beam steering). The system may lack optical elements or physical structures that impede or contact the final amplified beam after the last amplification stage to reduce a likelihood of damage to optical elements and coatings.

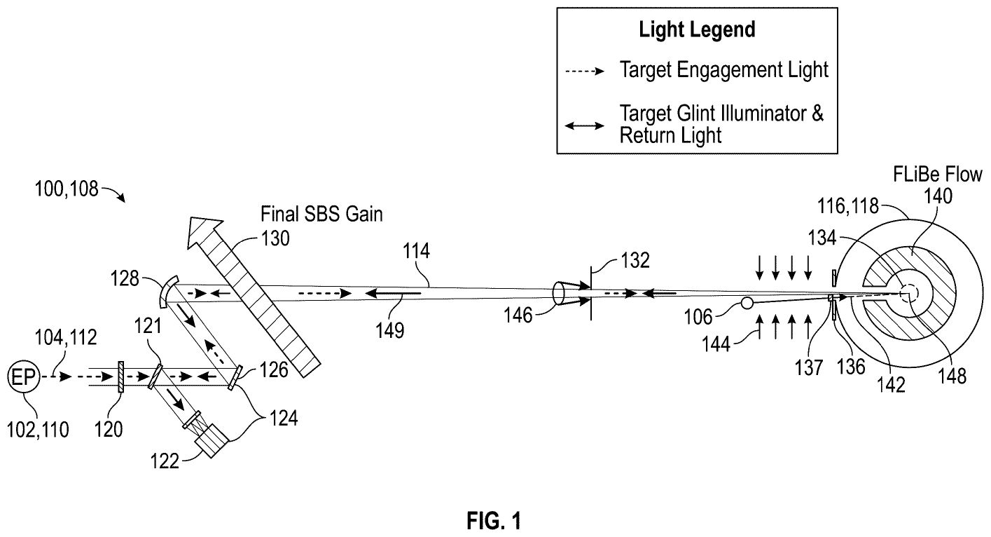

Referring to FIG. 1, a schematic view of a fusion system is shown in accordance with an embodiment. A fusion system 100 can include an energy pulse source 102 to generate an energy beam 104 that can be directed to a target 106. The fusion system 100 can be, for example, an inertial confinement fusion (ICF) system or an inertial fusion energy (IFE) system. The ICF system may operate on a single-shot, non-repetitive basis. Alternatively, the IFE system may operate continuously, in a pulsed fashion, e.g., at a frequency of one shot per second. Accordingly, the fusion system may have an architecture to perform a fusion process.

The fusion system 100 may be more broadly described as a target tracking system 108, in which the energy pulse source 102 includes a laser pulse source 110 to generate the energy beam 104, e.g., a laser beam 112. The laser beam 112 can be directed to the target 106. It will be appreciated then, that although the target tracking system 108 may be used in a fusion process and may thus be termed the fusion system 100, the target tracking system 108 may be used in other applications that require precision focused-laser target engagement.

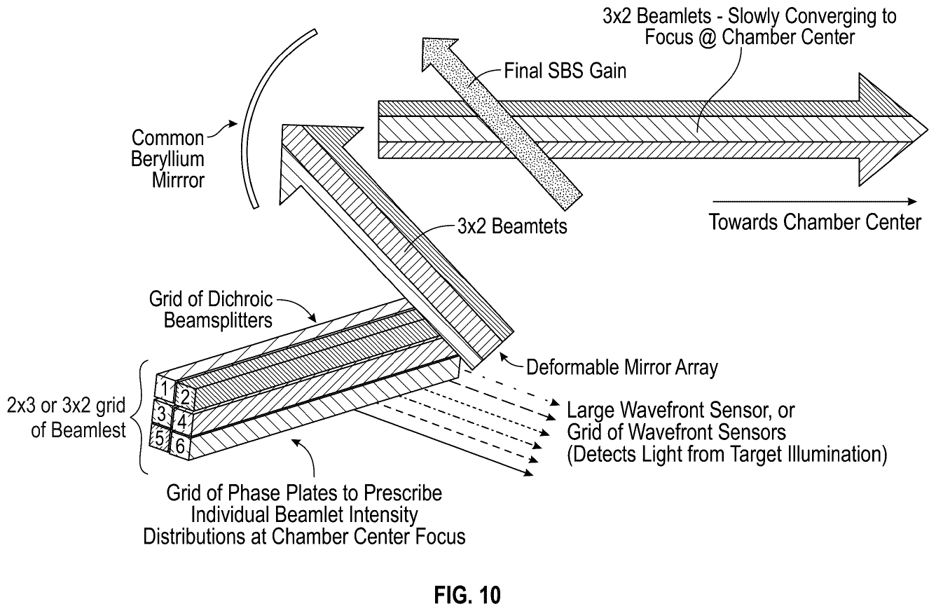

The energy pulse source 102 can include one or more front end laser sources to generate a grid of co-aligned beamlets (FIG. 10). The beamlets can be square beams having rounded edges that combined to form the energy beam 104. In an embodiment, the front end laser sources are excimer lasers. Accordingly, the energy beam 104 can include light at wavelengths of 248 nm or 193 nm.

The beamlets can pass through amplification operations and additional beamlines can be combined to output, from the energy pulse source 102, the energy beam 104 as an m×n grid of co-aligned, square, time-staggered collimated beamlets having respective side lengths. For example, the energy beam 104 can include a collimated 3×2 beam array having beamlets with cross-sections measuring 25 cm by 25 cm. The energy beam 104 having the beamlets can enter an optical path 114 of the fusion system 100, the path being directed toward a reaction chamber 116 of the system. The reaction chamber 116 can be a vacuum chamber 118 within which a fusion reaction occurs, for example.

The collimated beamlets of the energy beam 104 can enter the optical path 114 after pre-amplification. When entering the optical path 114, the beamlets can be timed. For example, the beamlets may be time-gapped by a predetermined lag. In an embodiment, a delay of 10-15 ns, e.g., 12 ns, exists between the entry of each beamlet into the optical path 114.

The beamlets can propagate along the optical path 114 and pass through a phase plate array 120. The phase plate array 120 can include a grid of m×n phase plates, matching the grid of beamlets, to impart an individual phase prescription to each beamlet. Each beamlet of the energy beam 104 can pass through a respective phase plate of the phase plate array 120 to develop an optimized intensity profile pattern during final focus of the beamlet. More particularly, phase plate array 120 can put a prescribed phase on each beamlet to control an intensity profile or intensity distribution of the energy beam 104 at the point of focus. The point of focus can be at the target 106 in the reaction chamber 116, e.g., where the energy beam 104 strikes the target 106. The term “strike,” as used herein, can refer to the process of laser interaction with, irradiation of, or incidence on the target. The struck target can absorb the laser in a manner sufficient to achieve implosion and fusion ignition, as required by a specific target design.

After undergoing preamplification, the beamlets can transmit through a beamsplitter 121. The beamlets can remain at a nominally uniform intensity as they pass through the beamsplitter 121. The beamsplitter 121 can be a dichroic beamsplitter that directs a portion of light from the beamlets toward a wavefront sensor array 122. As described below, the wavefront sensor array 122 can be a component of a beam steering system 124 used to steer the energy beam 104 toward the moving target 106. More particularly, the beam steering system 124 can include the wavefront sensor array 122 and a deformable mirror array 126. The wavefront sensor array 122 can detect tilt and wavefront error in the beamlets, and the deformable mirror array 126 can impart tilt and wavefront correction.

A portion of the energy beam 104 can transmit through the beamsplitter 121 toward the deformable mirror array 126. The deformable mirror array 126 can have an m×n grid of deformable mirrors (e.g., a 3×2 grid) and, thus, each beamlet can reflect off of a respective deformable mirror to continue along the optical path 114 toward the target 106. Each deformable mirror can include a global tip/tilt mechanism that can be moved by one or more actuators to impart phase and steering on the beamlets. Accordingly, each deformable mirror can be capable of independently imparting dynamically prescribed high order phase and global x/y tilt correction to a respective beamlet. More particularly, the deformable mirror array 126 can correct wavefront error sensed by the wavefront sensor array 122. Accordingly, the beam steering system 124 can meet a technical need to compensate for wavefront error in the laser pulses, prior to exceeding a threshold fluence level, to ensure diffraction limited focus profiles engage the target 106 at the center of the reaction chamber 116.

The phase and tilt corrected beamlets can propagate forward along the optical path 114 toward a parabolic mirror 128. The beamlets can reflect from the parabolic mirror 128 to converge toward the center of the reaction chamber 116. The parabolic mirror 128 may be more than 25 m, e.g., 50 m, from the chamber center.

In an embodiment, the parabolic mirror 128 includes a global off-axis parabolic mirror. The parabolic mirror 128 can be a final optic in the optical path 114 between the energy pulse source 102 and the reaction chamber 116. Accordingly, the energy beam 104 can reflect and converge with a slow focal ratio from the parabolic mirror 128 to the center of the reaction chamber 116.

Beryllium can be selected as a material for the parabolic mirror 128, the final focusing optic, to ensure minimal long-term damage from neutron bombardment emanating from the reaction chamber 116 at a small solid angle during fusion ignition. More particularly, only the off-axis parabolic Beryllium mirror may experience neutron bombardment, which can protect the other optics in the optical path 114 from damage.

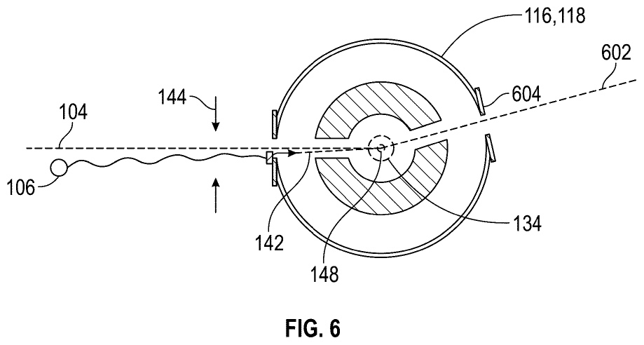

The energy beam 104, after reflecting forward from the off-axis parabolic mirror 128, can have a fluence level that is less than a threshold fluence level to ensure that no laser induced damage occurs to the optical elements and coatings in the optical path 114. The non-destructive beamlets can enter a Stimulated Brillouin scattering (SBS) laser amplifier, which can perform an amplification stage. The SBS amplifier 130 can output the energy beam 104 at a fluence level that is above the threshold fluence level. In an embodiment, the energy of each beamlet in the energy beam 104 is 1 MJ. For example, the energy beam 104 may have a 3×2 grid of beamlets, totaling an energy transfer of 6 MJ to the target for a single-sided configuration. Similarly, for a double-sided configuration (FIG. 6) having a second energy beam 104, the total energy transfer can be 12 MJ. Accordingly, the optical path 114 may lack physical structures in the beam path between the SBS amplifier 130 and the reaction chamber 116 to avoid destruction of such structures by the energy beam 104. After the final focusing of the off-axis parabolic mirror 128 and the SBS amplifier 130, the beamlets can converge to an f-number of 150 to 250, e.g., 200. The energy beam 104 can therefore travel to engage target 106 at the final focus in the chamber center without encountering physical structures, including optical elements.

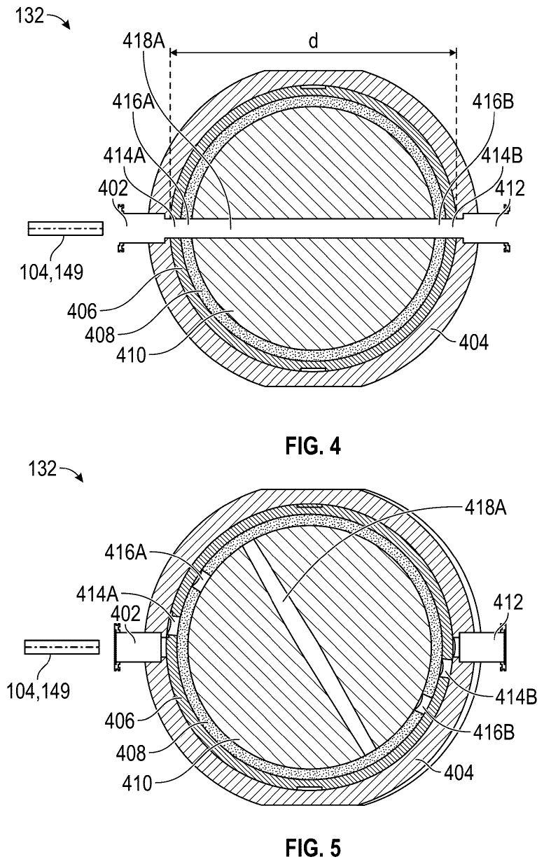

In an embodiment, the energy beam 104 passes forward through a shutter apparatus 132. The shutter apparatus 132 can include a vacuum shutter. As described below with respect to FIGS. 4-5, the shutter apparatus 132 can permit passage of the energy beam 104 from a higher pressure zone to a lower pressure zone without optical elements. More particularly, the energy beam 104 can pass through free space within the shutter apparatus 132 without striking structures of the shutter apparatus 132. By way of example, the energy beam 104 can pass through a 30 cm by 20 cm or larger aperture, without touching a physical structure, and can propagate forward toward the chamber center. The vacuum shutter may be more than 10 m, e.g., 20 m, from the chamber center.

The energy beam 104 can propagate forward from the shutter apparatus 132 toward the reaction chamber 116. The energy beam 104 can be directed to a strike zone 134 inside of the reaction chamber 116. For example, the energy beam 104 can pass through an entry port 136 in the reaction chamber 116. In an embodiment, the entry port 136 includes a 25-45 cm, e.g., 32 cm, diameter aperture. The aperture can allow passage of the energy beam 104 into the reaction chamber 116. The reaction chamber 116 may have a radius of 1-10 m, e.g., 5 m and, thus, the entry port 136 may open a small portion of the chamber wall. An energy absorbing shell 140, formed by a flow of FLiBe (a molten salt made from a mixture of lithium fluoride (LiF) and beryllium fluoride (BeF₂)), can encompass the strike zone 134. The fusion system 100 can include a slug injector 137 to create the entry port 136 in the shell 140. For example, the slug injector can include a nozzle to blast or create temporary openings in the shell 140. The entry port 136 can extend through the energy absorbing shell 140 to allow the energy beam 104 to pass toward the strike zone 134.

The fusion system 100 can include a target propulsion system. The target propulsion system can inject the target 106 into the reaction chamber 116. The target propulsion system can launch the target 106, e.g., a fusion fuel pellet, along a trajectory 142 that extends from outside the reaction chamber 116 to the strike zone 134 inside of the reaction chamber. The target injection may occur at an angle of 1-5 degrees, e.g., 1.6 degrees, from a longitudinal axis of the optical path 114 along which the energy beam 104 travels. For example, the injection location can be at a location between the entry port 136 and the shutter apparatus 132, e.g., 10 m from the chamber center, and the target 106 can accelerate from rest at the injection location along the trajectory 142. The target propulsion system can incorporate an air-powered propulsion system that shoots the target 106 along the trajectory 142 toward a chamber center within the strike zone 134. Accordingly, although the trajectory 142 may have a curvilinear path along which the target 106 travels in free space, it may essentially be a straight path because the target 106 moves at high speed.

In an embodiment, the fusion system 100 includes one or more tracking systems to track motion of the target 106 along the trajectory 142. For example, a first tracking system 144 can generate first tracking data based on the trajectory 142 of the target 106 outside of the reaction chamber 116. As described below, a processing device of the fusion system 100 can determine, based on the first tracking data, whether the trajectory 142 is directed to the strike zone 134. The processing device may, in response to determining that the trajectory 142 of the target 106 is directed to the strike zone 134, activate or fire the energy pulse source 102 to generate the energy beam 104.

The first tracking system 144 can include crossing sources or crossing cameras. More particularly, one or more crossing sources can direct light, transverse to the trajectory 142 of the target 106, toward one or more corresponding crossing cameras. The inline crossing sources/cameras may include several crossing sources/cameras spaced at intervals. When the target 106 passes through the light, the cameras can detect the target 106. The processing device connected to the crossing cameras can determine the trajectory or velocity of the target 106. Accordingly, the first tracking system 144, which can perform a first tracking stage outside of the reaction chamber 116, can determine whether and when the target 106 will enter the strike zone 134 within the reaction chamber 116.

The first tracking system 144 may include any tracking system that can detect the trajectory or speed of the target 106. For example, instead of or in addition to crossing cameras, the first tracking system 144 can include a light detection and ranging (LiDAR) system. The LiDAR system can be used to track the target 106 and generate first tracking data for use in event timing.

The fusion system 100 may include a second tracking system 146. The second tracking system 146 can include one or more light sources separate from sources of the first tracking system 144. For example, the second tracking system 146 can include glint illumination to flood the optical path 114 with diffuse light. The glint illumination can include a bright ring illumination source between the SBS amplifier 130 and the shutter apparatus 132. The illumination can travel to or through the entry port 136 and reflect from the moving target 106 as it moves toward a strike location 148 inside of the reaction chamber 116. Such reflection may occur immediately after the target 106 is fired toward the chamber center, and return light 149 may propagate backward along the optical path 114, through the shutter apparatus 132, the SBS amplifier 130, and the optical elements to arrive at the wavefront sensor array 122. The wavefront sensor array 122 can detect the diffuse reflection.

In an embodiment, the second tracking system 146 generates second tracking data that, like the first tracking data, represents the trajectory 142 of the target 106. For example, the wavefront sensor array 122 can generate the second tracking data based on the observed return light 149. The second tracking data, however, can represent the trajectory 142 inside of the reaction chamber 116 rather than outside of the reaction chamber 116.

The second tracking data generated by the second tracking system 146 can be used to control beam steering of the energy beam 104. For example, as described below, the processing device of the fusion system 100 can determine, based on the second tracking data, the strike location 148 within the strike zone 134. The strike location 148 can be a location that the trajectory 142 of the target 106 and the optical path 114 intersects. In an embodiment, the processing device can actuate the beam steering system 124 to steer the energy beam 104 along the optical path 114 to the strike location 148. Accordingly, the steered beam can strike the target 106 in mid-flight to initiate fusion within the strike zone 134 at the strike location 148.

The second tracking system 146 can use back illumination when the target pellet can be adequately coated with a diffuse reflective coating to allow for direct observation by the wavefront sensor array 122. For example, the glint illumination can include the bright ring illumination source to cause reflection from such coating, as described above. Alternatively, inline illumination sources may be placed between the mirrors of the deformable mirror array 126 to direct light along the optical path 114 to the target pellet coating. When such coating is not possible, however, alternative means of sending light backward along the optical path 114 to the wavefront sensor array 122 may be used. In an embodiment, the target pellet can self-emit light, e.g., via fluorescence or otherwise, to send light toward the wavefront sensor array 122.

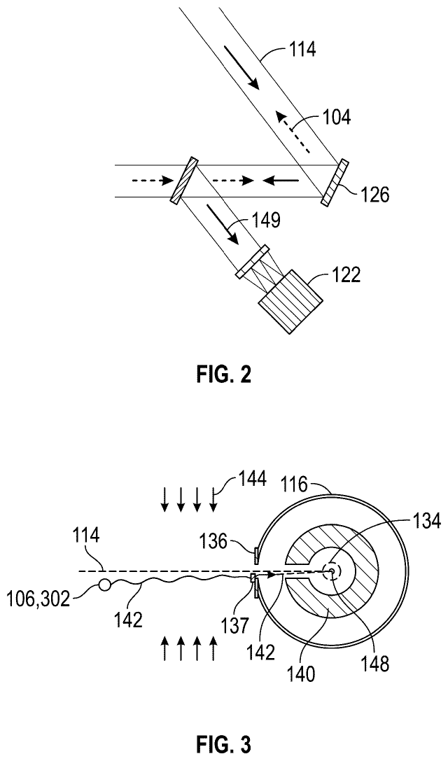

Referring to FIG. 2, a side view of a beam steering system is shown in accordance with an embodiment. In an embodiment, the second tracking system 146 includes the wavefront sensor array 122 to generate the second tracking data. The wavefront sensor array 122 can generate the second tracking data based on the return light 149 traveling proximally (backward) along the optical path 114 from the target 106. More particularly, the return light 149 can be detected by the wavefront sensor array 122 and corresponding transduced signals can be received and processed by the processing device.

In embodiment, the beam steering system 124 includes the wavefront sensor array 122 and the deformable mirror array 126. The deformable mirror array 126 can, as described above, include several mirrors that deform to correct errors in the energy beam 104 wavefront or steer the energy beam to impinge on the strike location 148 within the strike zone 134. More particularly, the processing device can control actuation of the deformable mirror array 126 to direct the energy beam 104 distally (forward) to intersect the strike location 148 coincident with passage of the target 106. The energy beam 104 can therefore initiate fusion of the target 106.

Referring to FIG. 3, a cross-sectional view of a target injection into a chamber is shown in accordance with an embodiment. As described above, the target 106 can be injected at a target injection location 302 and propelled along the trajectory 142 through the first tracking system 144 and the entry port 136 into the reaction chamber 116. The first tracking system 144 can detect the trajectory 142 or velocity of the target 106 outside of the reaction chamber 116. First tracking data may be useful, for example, in determining whether the target 106 is heading toward the strike zone 134, which may be a spatial envelope having a first size. For example, the first size may be a spherical spatial envelope having a diameter of 10-100 microns, e.g., 25 microns. Similarly, the second tracking system 146 can detect the trajectory 142 or velocity of the target 106 inside of the reaction chamber 116. Second tracking data may be useful, for example, in determining whether the target 106 is heading toward the strike location 148, which can be a discrete location or a spatial envelope within the strike zone 134 and having a second size smaller than the first size. For example, the second size may be a spherical spatial envelope having a diameter of 1-10 microns, e.g., 5 microns. The first tracking system 144 and the second tracking system 146 may therefore generate data useful for determining whether the trajectory 142 is directed to the strike zone 134 or strike location 148. The beam steering system 124 can steer the energy beam 104 to the strike location 148 based on the tracking data. In an embodiment, the trajectory 142 is detected and the energy beam 104 is steered to the strike location 148 by the beam steering system 124 while the target 106 is in flight. More particularly, determining the trajectory 142 path to the strike location 148 and steering the energy beam 104 to the strike location 148 can occur when the target 106 is traveling from the target injection location 302 outside of the reaction chamber 116 to the strike location 148 inside of the reaction chamber 116.

The fusion system 100 can include the shutter apparatus 132 to maintain a higher pressure zone containing the energy pulse source 102 and the optical elements of the system, and a lower pressure zone containing the reaction chamber 116. The shutter apparatus 132 can be located along the optical path 114 and may include a shutter port 402 that can cyclically or periodically actuate between an open state (FIG. 4) and a closed state (FIG. 5). When in the open state, the shutter port 402 can provide a line of sight along the optical path 114 from the final optical element of the fusion system 100 to the strike location 148 within the reaction chamber 116. An embodiment of the shutter apparatus 132 is described below. It will be appreciated, however, that other shutter apparatus embodiments may be used to provide line of sight passage of the energy beam 104 and the return light 149 during the open state of the shutter. More particularly, the open state of the shutter apparatus 132 can be time synchronized to allow the return light 149 to travel proximally along the optical path 114 from the target 106 through the open shutter port 402 to queue the steering system, and to allow the steered energy beam 104 to travel distally along the optical path 114 through the shutter port 402 to strike the target 106 in the reaction chamber 116. For example, suitable shutter apparatus embodiments (one of which is described below) are described in U.S. application Ser. No. 18/592,359, to Cyrus M. Herring, et al., filed on Feb. 29, 2024, entitled “Shutter Apparatus Having Ports To Control Energy Beam And Gas Transfer Between Zones,” the contents of which are incorporated herein by reference. The suitable shutter apparatuses can provide line of sight passage of the energy beam 104 and return light 149 through the shutter port 402 during a same open state of the shutter apparatus 132.

Referring to FIG. 4, a cross-sectional view of a shutter apparatus in an open state is shown in accordance with an embodiment. The shutter apparatus 132 is shown in a fully aligned, or open, state. In an embodiment, the shutter apparatus 132 includes an outer external body 404, an outer drum 406, a middle drum 408, and an inner drum 410 located concentrically inside the external body 404. The external body 404 includes the shutter port 402 exposed to a higher pressure zone upstream of the shutter apparatus 132 (toward the energy pulse source 102) and a second shutter port 412 exposed to a lower pressure zone downstream of the shutter apparatus 132 (toward the reaction chamber 116). The outer drum 406 includes drum ports 414A and 414B, the middle drum 408 includes drum ports 416A and 416B, and the inner drum 410 includes drum port 418A. The body or drums can be rotatable relative to each other. For example, the outer drum 406 can be rotatable within the external body 404. Similarly, the middle drum 408 can be rotatable within the outer drum 406.

Rotation of the drums can align the drum ports with each other or with the shutter ports 402, 412 of the outer external body 404. For example, the outer drum 406 can rotate within the outer external body 404 to align the drum ports 414A, 414B with the shutter port 402 and the second shutter port 412. The ports can align along a line of sight. More particularly, the shutter port 402 and the second shutter port 412 can be longitudinally aligned and separated by a distance, d, along a line of sight axis. The line of sight axis may be the axis along which the energy beam 104 and the return light 149 travel, and the shutter ports 402, 412 can be aligned when the line of sight axis extends through the ports (allowing the energy beam 104 to pass through the aligned ports in a distal direction and the return light 149 to pass through the aligned ports in a proximal direction). When the shutter port 402 is aligned with the drum ports, the shutter port 402 can be open to the second shutter port 412 through the drum ports.

Opening the shutter port 402 to the second shutter port 412 can require additional ports of the shutter apparatus 132 to align. For example, the middle drum 408 may rotate to move the drum port 416A into alignment with the drum port 418A. When the drum ports 414A, 416A, 418A, 416B, and 414B are aligned with each other and the shutter ports 402, 412, along the line of sight axis, the shutter port 402 can open to the second shutter port 412 and the energy beam 104 can travel through the shutter apparatus 132 from the higher pressure atmosphere in the upstream zone to the lower pressure atmosphere in the downstream zone. Similarly, when the drum ports are aligned with each other and the shutter ports 402, 412, along the line of sight axis, the shutter port 402 can open to the second shutter port 412 and the return light 149 can travel through the shutter apparatus 132 from the lower pressure atmosphere to the higher pressure atmosphere

The rotational speeds of the outer drum 406, the middle drum 408, and the inner drum 410 can be set such that the alignment of the drum ports occurs at a predetermined periodicity. The periodicity can be selected such that alignment of the ports, or the port opening caused by such alignment, does not exist for a sufficient time to permit gas within the higher pressure atmosphere (e.g., neon or helium) to pass along the full distance, d, between the shutter ports 402, 412. Gas transmission is a function of the molecular velocity of the gas, e.g., V_{He/Ne}. Thus, if the distance, d, is greater than the molecular velocity of the gas times a time, t₀, during which the ports are aligned or open to each other, then the direct pathway between the gaseous and evacuated sides will not be open sufficiently long to permit gas to travel into the evacuated environment. With this in mind, transfer of gas from the first atmosphere to the second atmosphere can be minimized by observing the governing equation: d>(V_{He/Ne})*(tₒ). More particularly, gas transfer can be minimized by selecting an appropriate distance between the ports 402, 412.

Instead of or in addition to controlling distance between the shutters to limit gas transfer between atmospheres, the gas transfer may also be minimized by controlling the shutter open time of the shutter apparatus 132. A free path transit time, t_{fp}, of the gas across a given distance, d, can be defined as t_{fp}=d/V_{HeNe}. When the free path transit time for the gas to travel across the distance between the shutter ports 402, 412 is less than the shutter open time of the shutter apparatus 132, then the gas will not travel entirely through the channel into the second atmosphere. More particularly, gas transfer between the atmospheres can be minimized or eliminated by setting the shutter open time to be less than the free path transit time.

Referring to FIG. 5, a cross-sectional view of a shutter apparatus in a closed state is shown in accordance with an embodiment. The shutter apparatus 132 is in a non-aligned, or closed, state. The drums can rotate relative to each other to move respective ports into misalignment with each other. More particularly, note that the line of sight axis along which the energy beam 104 and the return light 149 are directed does not pass through the drum ports. In the non-aligned state, the ports may be closed off to each other, and neither the energy beam 104, the return light 149, nor the gas in the higher pressure atmosphere can travel from the shutter port 402 to the second shutter port 412.

Based on the above description, it will be appreciated that the energy beam 104 and the return light 149 can pass through the shutter ports 402, 412 in opposite directions during the open state of the shutter apparatus 132 and before the gas can leak from the higher pressure atmosphere to the lower pressure atmosphere. During the open time, a fast convergence of the gas may occur toward the lower pressure atmosphere. More particularly, when the shutter ports and drum ports align to create a channel for the transfer of light and gas, the gas can rush into the open channel. The surge of the gas toward the reaction chamber 116 can cause turbulence, which may cause diffraction of the energy beam 104 or the return light 149 passing through the open channel.

In an embodiment, the fusion system 100 adjusts the beam steering system 124 to correct for distortion of the energy beam 104 or the return light 149 caused by the shutter apparatus function. The surge of gas through the shutter apparatus 132 may be repeatable and deterministic, and can be characterized through computational fluid dynamics (CFD). More particularly, turbulence and a resulting light distortion effect can be characterized. The processing device can control the steering system to adjust for the distortion effect. For example, the deformable mirror array 126 may be actuated to correct for off-set and phase distortion of the converging beamlets passing through the rushing gas as the energy beam 104 travels forward toward the strike location 148.

Referring to FIG. 6, a cross-sectional view of a target injection into a chamber is shown in accordance with an embodiment. The fusion system 100 may include several energy pulse sources to direct several energy beams toward the target 106. In an embodiment, the fusion system 100 includes a second energy pulse source (not shown) to generate or fire a second energy beam 602 toward the strike zone 134 inside of the reaction chamber 116. The second energy pulse source can direct the second energy beam 602 toward the strike location 148, or to a second strike location offset from the strike location 148 along the trajectory 142. The second energy beam 602 can be directed along a second optical path that is different than the optical path 114. For example, the second energy beam 602 may enter the reaction chamber 116 on a different side than the energy beam 104 or the target 106. Entry of the second energy beam 602 can be facilitated by similar structures to those described above, such as a second shutter apparatus or a second entry port 604 in the reaction chamber 116. Similarly, generating, firing, or steering of the second energy beam 602 can be facilitated by similar structures to those described above, such as a second steering system.

The energy beam 104 and the second energy beam 602 can be steered to strike the target 106 at the strike location 148. Tracking of the target 106 may be performed by the first tracking system 144 or the second tracking system 146 (not shown), and adjustments to the steering systems can be made in response to such tracking. More particularly, the energy beams 104, 602 may be generated or fired and steered to intercept the target 106 at the chamber center to initiate fusion.

Generating (firing) and steering of the second energy pulse source and second energy beam 602 may be made based on tracking data from the first tracking system 144 or the second tracking system 146. For example, the processing device may be configured to activate or fire the second energy pulse source when the trajectory 142 of the target 106 is directed to the strike zone 134. Steering of the second energy beam 602 may be in response to tracking data generated by the second tracking system 146. Alternatively, a third tracking system may be provided in line with the second optical path to generate third tracking data. The third tracking data can determine movement of the target 106 within the reaction chamber 116 in a line of sight of the second optical path. Adjustments to the second steering system can be made to steer the second energy beam 602 to intersect the trajectory 142 of the target 106 at the strike location 148, or at the second strike location 148 offset from the strike location along the trajectory 142.

Having described the structure of the fusion system 100 (or the target tracking system 108), the description now turns to methods of target tracking that can be performed by the system. More particularly, energy beam control can be performed in response to tracking of the target 106 outside and inside of the vacuum chamber 118. Such control can include fail-safes to activate or fire the energy pulse source 102 only when the target 106 is on a trajectory 142 that can be intercepted by the energy beam 104, or steering the energy beam 104 to strike the target 106 inside of the reaction chamber 116. Method operations, which can be performed by the fusion system components under control of the processing device, are described below.

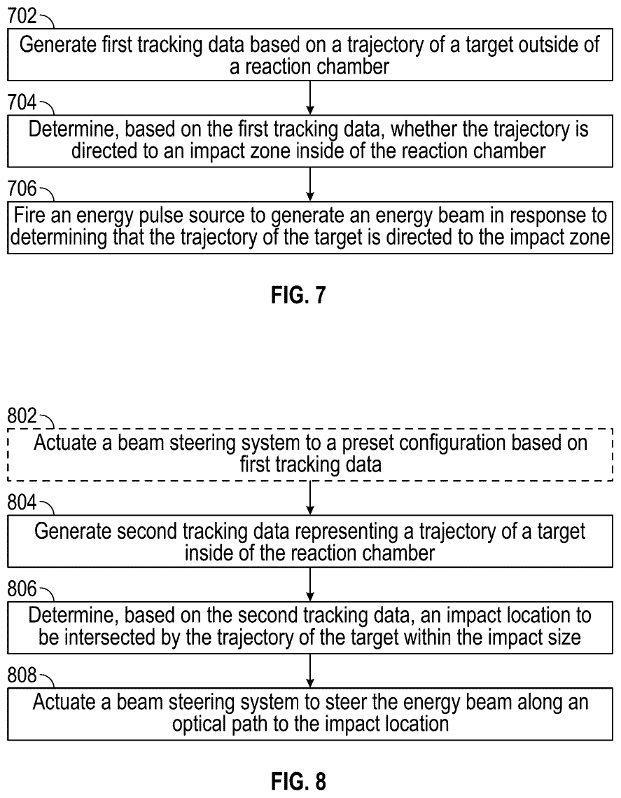

Referring to FIG. 7, a flowchart of a method of generating an energy beam based on target tracking is shown in accordance with an embodiment. At operation 702, the first tracking system 144 generates first tracking data based on the trajectory 142 of the target 106 outside of the reaction chamber 116. The first tracking data can represent an instantaneous position, velocity, or acceleration of the target 106 to allow the trajectory 142 of the target 106 and an expected future position, e.g., within the strike zone 134, to be determined.

At operation 704, the processing device determines, based on the first tracking data, whether the trajectory 142 is directed to the strike zone 134 inside of the reaction chamber 116. The strike zone 134 can be the spatial envelope within which the energy beam 104 is capable of being steered by the beam steering system 124.

At operation 706, the energy pulse source 102 is activated or fired to generate the energy beam 104. Generating or firing of the energy pulse source 102 can be in response to determining that the trajectory 142 of the target 106 is directed to the strike zone 134. More particularly, the energy pulse source 102 may not be activated or fired when the processing device determines that the trajectory 142 is not directed to the strike zone 134 inside of the reaction chamber 116. Accordingly, the first tracking data can be used by the processing device to make a go-no-go decision regarding whether to attempt to initiate fusion of the moving target 106.

The determination of the trajectory 142 based on the first tracking data can act as a fail-safe to ensure general safety practices and to prevent equipment damage. When the energy beam 104 cannot intercept the target 106, e.g., when the first tracking system 144 detects anomalies with an initial target velocity or trajectory, generating or firing of the energy pulse source 102 or the SBS amplifier 130 can be deactivated to avoid damage or increase the lifetime of the energy pulse source 102 or the reaction chamber 116.

The fail-safe operation enabled by the first tracking data may represent a first stage of fail-safes provided by the fusion system 100. In an embodiment, additional feedback from the wavefront sensor array 122 may facilitate a second stage of fail-safes. For example, when the wavefront sensor array detects deviations in target trajectory 142 such that achievable beam steering via the deformable mirror array 126 cannot direct the energy beam 104 to engage the target 106, the energy pulse source 102 or the SBS amplifier 130 may be deactivated. Similarly, when the wavefront sensor array 122 detects unachievable phase compensation is required by the deformable mirror array 126 for appropriate fusion initiation, the energy pulse source 102 or the SBS amplifier 130 may be deactivated. Deactivation of the energy pulse source 102, to not generate or fire the energy beam 104, can be based on alternative system data, such as data generated in response to a detection of a vacuum shutter malfunction. Accordingly, the determination to activate or not activate (fire or not fire) the energy pulse source 102 may be based on the first tracking data, the second tracking data, or additional system data indicating that fusion cannot be initiated.

Referring to FIG. 8, a flowchart of a method of steering an energy beam based on target tracking is shown in accordance with an embodiment. At operation 802, optionally, the processing device may be configured to actuate the beam steering system 124 to a preset configuration based on the first tracking data. The first tracking system 144 can provide a rough estimation of a future position of the target 106 based on the instantaneous trajectory data. The first tracking data can be based on non-line of sight tracking and, thus, may not reliably predict the strike location 148, however, the first tracking data may reliably predict a region within the strike zone 134 at which the target 106 will arrive. In an embodiment, the processing device can actuate the beam steering system 124 based on the first tracking data to deform one or more of the deformable mirrors of the deformable mirror array 126 such that the energy beam 104, when generated or fired, will be directed to the predicted region. The preset configuration can minimize the movement required by the deformable mirror array 126 to achieve a final steering configuration that will direct the energy beam 104 to the strike location 148 once the strike location 148 is known based on the second tracking data.

At operation 804, the second tracking system 146 generates the second tracking data representing the trajectory 142 of the target 106 inside of the reaction chamber 116. The return light 149 can pass through the shutter apparatus 132 to arrive at the wavefront sensor array 122, and the second tracking data can be generated based on the return light 149. The second tracking data can represent the instantaneous position, velocity, or acceleration of the target 106 within the reaction chamber 116. The second tracking data is generated based on the return light 149 traveling in line with the optical path 114. Advantageously, monitoring the optical path 114 along which the energy beam 104 will eventually pass can ensure that localized variations in the atmosphere of the optical path 114 are inherently accounted for within the tracking data. More particularly, monitoring the return light 149 that is in line with the energy beam 104, rather than viewing the target 106 off axis from the optical path 114, can provide beam steering based on the environment through which the energy beam 104 will travel, including the channel through the shutter apparatus 132.

At operation 806, the processing device determines, based on the second tracking data, the strike location 148 to be intercepted by the trajectory 142 of the target 106 within the strike zone 134. The strike location 148 can be an instantaneous position of the target 106 within the strike zone 134 at which the energy beam 104 can be steered to intercept the target 106.

At operation 808, processing device actuates the beam steering system 124 of the fusion system 100 to steer the energy beam 104 along the optical path 114 to the strike location 148. The deformable mirror array 126 can be adjusted to direct the energy beam 104 through the optical path 114 to intercept the target 106. The energy beam 104 can pass through the shutter apparatus 132 when the shutter apparatus 132 is in a same open state during which return light 149 passed at operation 804. The energy beam 104 can strike the target 106 within the reaction chamber 116 to initiate fusion.

As described above, the fusion system 100 can include precision target tracking, beam steering, and phase compensation capability. Real-time beam steering and phase compensation of each beamlet can be performed by the wavefront sensor array 122 and the deformable mirror array 126 operating in a high temporal bandwidth closed loop manner. Bulk subaperture spot positions on the wavefront sensor array 122 can queue global tilt correction offsets on the deformable mirror 126 while relative subaperture spot positions can queue spatially dependent actuator positions for higher order phase correction. A Shack-Hartmann wavefront sensor array 122 may be used having sufficient subapertures to balance signal to noise and having sufficient phase error detection for performing the methods described above. The wavefront sensor array 122 can be spectrally narrow band filtered centered on the target illumination and/or emission source and broadband neutral density filtered to prevent saturation and/or damage from other sources.

The method described above can be performed according to timing and synchronization considerations. Several such considerations are described below.

In an embodiment, the target pellet launch are nominally time synchronized with appropriate offsets for average time of flight to chamber center while accounting for the propagation time of laser pulses from the front-end pulse source locations to chamber center. More particularly, the speed of the target launch can be selected such that sufficient time exists to track the target and make the necessary corrections to cause the energy beam 104 to strike the target 106 at the strike location 148.

In an embodiment, the energy pulse sources are time synchronized to all preamplification stages and final amplification stage SBS amplifier 130 (pump source) firing. The energy pulse source 102 can be initially queued from the first tracking data, e.g., generated by in-line cross cameras monitoring initial stage of target launch. For example, the first tracking data can be used to estimate a time of arrival of the target 106 at the strike zone 134 or the strike location 148 and the energy pulse source 102 can be activated or fired at a time to ensure that the energy beam 104 passes through the amplification stages to arrive at the strike location 148 simultaneously with the target 106.

In an embodiment, the firing of a pump beam for the SBS amplification stage is synchronized to fire to optimize an overlap between seed beamlets and the pump beam. The overlap can occur at the final SBS amplification stage.

In an embodiment, the illumination sources, e.g., the glint illumination source, can be timed to ensure that return light 149 reflects from the target 106 when the target pellet is in flight. More particularly, the glint illumination can shine light that reflects as the return light 149 when the target 106 is visible within the optical path 114 through the shutter apparatus 132 and the entry port 136.

In an embodiment, the shutter apparatus 132 is synchronized to ensure converging beamlets pass forward when the shutter is in an open position. More particularly, the shutter ports 402, 412 can remain in the open state at least until the energy beam 104 has passed through the channel into the lower pressure atmosphere. As described above, the shutter ports 402, 412 can close after the energy beam 104 passes through the second shutter port 412 and before the gas from the higher pressure atmosphere has traversed the distance between the shutter ports 402, 412 into the lower pressure atmosphere.

In an embodiment, the FLiBe nozzles (the nozzles used to open a port for the energy beam 104 and the return light 149 to pass into and out of the reaction chamber 116) are synchronized to ensure that the target pellet and the laser engagement pulses are not blocked on respective entries into the reaction chamber. The nozzles can close the port immediately after passage of the energy beam 104 or the target 106 to then block entrance (or exit) of energy into or out of an interior of the chamber.

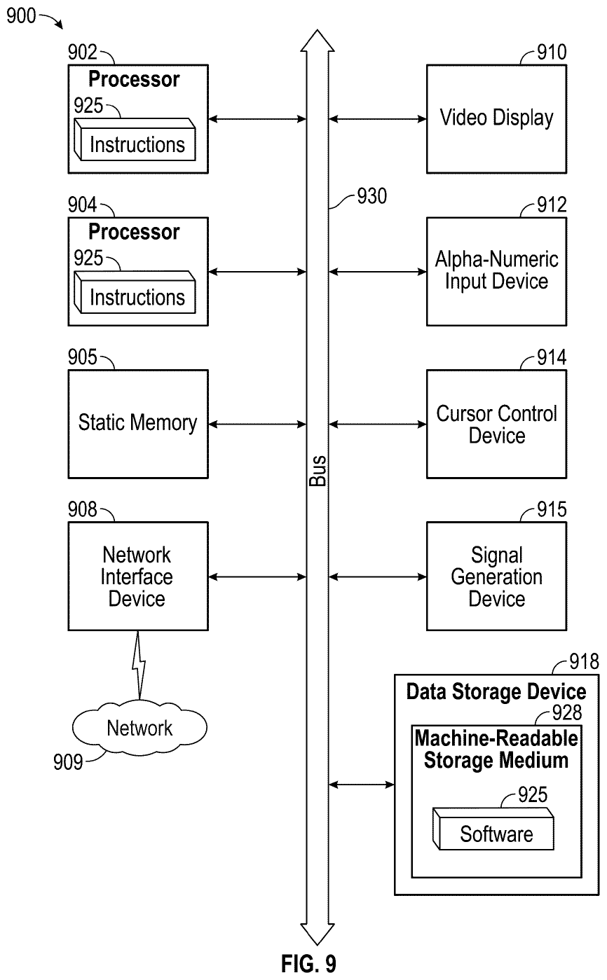

Referring to FIG. 9, a block diagram of an example computing device that may perform one or more of the operations described herein is shown in accordance with an embodiment. A computing device 900 may be integrated in any of the fusion systems described above to perform any of the described operations. Computing device 900 may be connected to other computing devices in a LAN, an intranet, an extranet, and/or the Internet. The computing device may operate in the capacity of a server machine in the client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 900 may include one or more processing devices 902 (e.g., a processing device, a general purpose processing device, a PLD, etc.), a main memory 904 (e.g., synchronous dynamic random access memory (DRAM), read-only memory (ROM)), a static memory 905 (e.g., flash memory and a data storage device), which may communicate with each other via a bus 930.

The one or more processing devices 902 may be provided by one or more general-purpose processing devices such as a microprocessor, central processing unit, or the like. In an illustrative example, processing device(s) 902 may comprise a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. Processing device(s) 902 may also comprise one or more special-purpose processing devices such as an application specific integrated circuit (ASIC), a field programmable gate array (FPGA), a digital signal processor (DSP), network processor, or the like. The processing device(s) 902 may be configured to execute the method operations described herein, in accordance with one or more aspects of the present disclosure, for performing the operations and steps discussed herein.

Computing device 900 may further include a network interface device 908 which may communicate with a network 909. The computing device 900 also may include a video display unit 910 (e.g., a liquid crystal display (LCD) or a cathode ray tube (CRT)), an alphanumeric input device 912 (e.g., a keyboard), a cursor control device 914 (e.g., a mouse) and an acoustic signal generation device 915 (e.g., a speaker). In one embodiment, video display unit 910, alphanumeric input device 912, and cursor control device 914 may be combined into a single component or device (e.g., an LCD touch screen).

Data storage device 918 may include a non-transitory computer-readable storage medium 928 on which may be stored one or more sets of instructions 925 that may include instructions for carrying out the operations described herein, in accordance with one or more aspects of the present disclosure. Instructions 925 may also reside, completely or at least partially, within main memory 904 and/or within processing device(s) 902 during execution thereof by computing device 900, main memory 904 and processing device(s) 902 also constituting computer-readable media. The instructions 925 may further be transmitted or received over a network 920 via network interface device 908.

While computer-readable storage medium 928 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding, or carrying a set of instructions for execution by the machine and that cause the machine to perform the methods described herein. The term “computer-readable storage medium” shall accordingly be taken to include, but not be limited to, solid-state memories, optical media, and magnetic media.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A fusion system, comprising:
a reaction chamber;
an energy pulse source to generate an energy beam;
a first tracking system to generate first tracking data based on a trajectory of a target outside of the reaction chamber; and
a processing device, operatively coupled to the first tracking system and the energy pulse source, to:
determine, based on the first tracking data, whether the trajectory is directed to a strike zone inside of the reaction chamber, and
activate the energy pulse source in response to determining that the trajectory of the target is directed to the strike zone.

2. The fusion system of claim 1 further comprising:
a second tracking system to generate second tracking data representing the trajectory of the target inside of the reaction chamber; and
a beam steering system;
wherein the processing device is further to:
determine, based on the second tracking data, a strike location to be intersected by the trajectory of the target within the strike zone, and
actuate the beam steering system to steer the energy beam along an optical path to the strike location.

3. The fusion system of claim 2, wherein the second tracking system includes a wavefront sensor array to generate the second tracking data based on light traveling proximally along the optical path from the target, and wherein the beam steering system includes a deformable mirror.

4. The fusion system of claim 2, wherein determining whether the trajectory is directed to the strike zone and controlling the beam steering system to steer the energy beam to the strike location occurs when the target is traveling from a target injection location outside of the reaction chamber to the strike location inside of the reaction chamber.

5. The fusion system of claim 2, wherein the processing device is to actuate the beam steering system to a preset configuration based on the first tracking data.

6. The fusion system of claim 2 further comprising a shutter apparatus along the optical path, wherein the shutter apparatus includes a shutter port, wherein return light travels proximally from the target through the shutter port, and wherein the energy beam travels distally through the shutter port.

7. The fusion system of claim 1 further comprising a second energy pulse source to generate a second energy beam toward the strike zone inside of the reaction chamber, wherein the processing device is to activate the second energy pulse source when the trajectory of the target is directed to the strike zone.

8. A target tracking system, comprising:
a vacuum chamber;
a first tracking system to generate first tracking data based on a trajectory of a target outside of the vacuum chamber;
a laser pulse source to generate a laser beam; and
a processing device, operatively coupled to the first tracking system and the laser pulse source, to:
determine, based on the first tracking data, whether the trajectory is directed to a strike zone inside of the vacuum chamber, and
activate the laser pulse source in response to determining that the trajectory of the target is directed to the strike zone.

9. The target tracking system of claim 8 further comprising:
a second tracking system to generate second tracking data representing the trajectory of the target inside of the vacuum chamber; and
a beam steering system;
wherein the processing device is further to:
determine, based on the second tracking data, a strike location to be intersected by the trajectory of the target within the strike zone, and
actuate the beam steering system to steer the laser beam along an optical path to intersect the strike location.

10. The target tracking system of claim 9, wherein the second tracking system includes a wavefront sensor array to generate the second tracking data based on light traveling proximally along the optical path from the target, and wherein the beam steering system includes a deformable mirror.

11. The target tracking system of claim 9, wherein determining whether the trajectory is directed to the strike zone and controlling the beam steering system to steer the laser beam to the strike location occurs when the target is traveling from a target injection location outside of the vacuum chamber to the strike location inside of the vacuum chamber.

12. The target tracking system of claim 9, wherein the processing device is to actuate the beam steering system to a preset configuration based on the first tracking data.

13. The target tracking system of claim 9 further comprising a shutter apparatus along the optical path, wherein the shutter apparatus includes a shutter port, wherein return light travels proximally from the target through the shutter port, and wherein the laser beam travels distally through the shutter port.

14. The target tracking system of claim 8 further comprising a second energy pulse source to generate a second laser beam toward the strike zone inside of the vacuum chamber, wherein the processing device is to activate the second energy pulse source when the trajectory of the target is directed to the strike zone, and to not activate the second energy pulse source when the trajectory of the target is not directed to the strike zone.

15. A method, comprising:
generating, by a first tracking system of a fusion system, first tracking data based on a trajectory of a target outside of a reaction chamber of the fusion system;
determining, by a processing device of the fusion system based on the first tracking data, whether the trajectory is directed to a strike zone inside of the reaction chamber; and
activating an energy pulse source of the fusion system to generate an energy beam in response to determining that the trajectory of the target is directed to the strike zone.

16. The method of claim 15 further comprising:
generating, by a second tracking system of the fusion system, second tracking data representing the trajectory of the target inside of the reaction chamber;
determining, by the processing device based on the second tracking data, a strike location to be intersected by the trajectory of the target within the strike zone; and
actuating, by the processing device, a beam steering system of the fusion system to steer the energy beam along an optical path to the strike location.

17. The method of claim 16, wherein the second tracking system includes a wavefront sensor array to generate the second tracking data based on light traveling proximally along the optical path from the target, and wherein the beam steering system includes a deformable mirror.

18. The method of claim 16, wherein determining whether the trajectory is directed to the strike zone and controlling the beam steering system to steer the energy beam to the strike location occurs when the target is traveling from a target injection location outside of the reaction chamber to the strike location inside of the reaction chamber.

19. The method of claim 16 further comprising actuating, by the processing device, the beam steering system to a preset configuration based on the first tracking data.

20. The method of claim 16 further comprising opening, by the processing device, a shutter apparatus along the optical path, wherein the shutter apparatus includes a shutter port, wherein return light travels proximally from the target through the shutter port, and wherein the energy beam travels distally through the shutter port.
